(19) United States
(12) Patent Application Publication
(10) Pub. No.: US 2026/0038480 A1
(43) Pub. Date: Feb. 5, 2026

(54) In-Vehicle Object Queries with Large Multi-Modal Models

(71) Applicant: Nissan North America, Inc., Franklin, TN (US)

(72) Inventors: Marcell Jose Vazquez-Chanlatte, Palo Alto, CA (US); Corey Heath, Scottsdale, AZ (US); Stefan Witwicki, San Carlos, CA (US); Tomer Arnon, Menlo Park, CA (US)

(21) Appl. No.: 18/790,931

(22) Filed: Jul. 31, 2024

(51) Int. Cl. G10L 13/08; G06V 20/59; G06V 20/70; G10L 15/22

(52) U.S. Cl. CPC G10L 13/08; G06V 20/59; G06V 20/70; G10L 15/22; G10L 2015/223

(57) ABSTRACT

System and method for responding to queries about objects in a cabin of a vehicle. The system detects a trigger that causes an in-cabin camera to capture video of the cabin, and the system generates a history of captions for at least selected frames of the video by a large multi-modal model (LMM). The system converts a spoken query received by a microphone to a text-based prompt and generates, by the LMM, a response to the prompt based on the history of captions. The response is converted to speech that is output to a speaker.

### TECHNICAL FIELD

This disclosure relates generally to obtaining information about objects in a cabin of a vehicle, and more particularly, to a large multi-modal model (LMM) that responds to queries about in-cabin objects from users.

### BACKGROUND

LMMs have advanced the field of artificial intelligence (AI) by enabling the seamless integration and processing of diverse data types such as text, images, audio, video, and more. These models, characterized by their ability to understand and generate content across multiple modalities, have demonstrated remarkable performance in a variety of applications, from natural language processing and computer vision to complex decision-making tasks. Their capacity to handle and synthesize information from different sources makes them particularly valuable in environments where diverse data streams need to be interpreted simultaneously.

One notable application of LMMs is in the context of in-cabin environments, such as those found in vehicles. In these settings, a variety of objects, from personal items to operational components, need to be identified, monitored, and managed to ensure safety, comfort, and efficiency. Traditional single-modal models often fall short in such dynamic and complex environments, as they are typically limited to processing one type of data at a time. In contrast, LMMs can leverage visual data from cameras, audio data from microphones, and textual data from onboard information systems to provide a comprehensive understanding of the in-cabin environment. While this disclosure provides examples of implementations with respect to the vehicle being an automobile, the cabins of other vehicles, such as airplanes, helicopters, trains, boats, are within the scope of this disclosure.

Embodiments disclosed herein leverage various strengths of LMMs to enhance detecting, recognizing, and describing in-cabin objects. For instance, a driver or passenger (e.g., a user) could inquire about the status or condition of an item left in the backseat, and the system would utilize visual and contextual data to provide an accurate response. Further, by continually or periodically capturing images and/or video with one or more cameras, performing object recognition on the images and/or video frames, and captioning the images and/or video frames, object histories can be created that allows the system to provide information about an object that may no longer be within respective fields of view of one or more cameras. For instance, a driver whose mobile phone unknowingly slid under the passenger seat could ask the system where his mobile phone is, and the system could infer that his mobile phone is most likely under the passenger seat based on the history of captions that describe locations or changes in locations of the mobile phone before it disappeared from the respective fields of view of the cameras. This capability not only enhances user experience but also contributes to safety and operational efficiency by ensuring that important objects are monitored and managed effectively.

Moreover, the integration of LMMs in in-cabin environments represents a significant advancement in smart vehicle technology. These models can learn and adapt to the unique characteristics of each vehicle and its occupants, providing personalized responses and improving over time through continuous learning. This adaptability ensures that the system remains relevant and effective as the vehicle's use and environment evolve. Additionally, the use of multi-modal data allows for a more robust and resilient system, capable of functioning accurately even when one type of data is temporarily unavailable or compromised.

In summary, LMMs offer a transformative approach to managing and interacting with in-cabin objects. Their ability to process and integrate various data types enables a deeper understanding and more nuanced handling of complex environments. Embodiments disclosed herein harness these capabilities to provide an intelligent, adaptive, and user-friendly solution for in-cabin object management, paving the way for safer, more efficient, and more enjoyable vehicle experiences.

### SUMMARY

Disclosed herein are aspects, features, elements, implementations, and embodiments of a method, a system, and a non-transitory computer-readable medium for responding to queries about in-cabin objects.

A first aspect of the disclosed implementations is a method for providing information about an in-cabin object, where the method includes: detecting a trigger that causes one or more in-cabin cameras to capture one or more videos of a cabin environment of a vehicle; generating a first caption for a first frame of a first video of the one or more videos by an LMM; receiving a query concerning the cabin environment by a microphone; converting the query to a text-based prompt; generating a response to the prompt by the LMM based on the first caption; converting the response to speech; and causing a speaker to output the speech.

A second aspect of the disclosed implementations is a system for providing information about an in-cabin object, where the system: detects a trigger that causes one or more in-cabin cameras to capture one or more videos of a cabin environment of a vehicle; generates a first caption for a first frame of a first video of the one or more videos by an LMM; receives a query concerning the cabin environment by a microphone; converts the query to a text-based prompt; generates a response to the prompt by the LMM based on the first caption; converts the response to speech; and causes a speaker to output the speech.

A third aspect of the disclosed implementations is a non-transitory computer-readable medium storing instructions operable to cause one or more processors to perform operations, where the operations comprise: detecting a trigger that causes one or more in-cabin cameras to capture one or more videos of a cabin environment of a vehicle; generating a first caption for a first frame of a first video of the one or more videos by an LMM; receiving a query concerning the cabin environment by a microphone; converting the query to a text-based prompt; generating a response to the prompt by the LMM based on the first caption; converting the response to speech; and causing a speaker to output the speech.

### BRIEF DESCRIPTION OF THE DRAWINGS

The various aspects of the methods and systems disclosed herein will become more apparent by referring to the examples provided in the following description and drawings in which like reference numbers refer to like elements unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a block diagram of an example internal configuration of a computing device of an electronic computing and communications system in which the aspects, features, and elements disclosed herein may be implemented.

FIG. 4 is a diagram of an example of a system for responding to queries about in-cabin objects that is integrated with a vehicle.

FIG. 5A is a diagram of an example of a sequence of video frames, where a subset of the frames may be saved and/or captioned; and FIG. 5B is a diagram of an example of a sequence of captions of a set of video frames, where a subset of the captions may be saved.

FIG. 6 is a flowchart of an example of a process for responding to queries about in-cabin objects.

### DETAILED DESCRIPTION

To describe some implementations in greater detail, reference is made to the following figures.

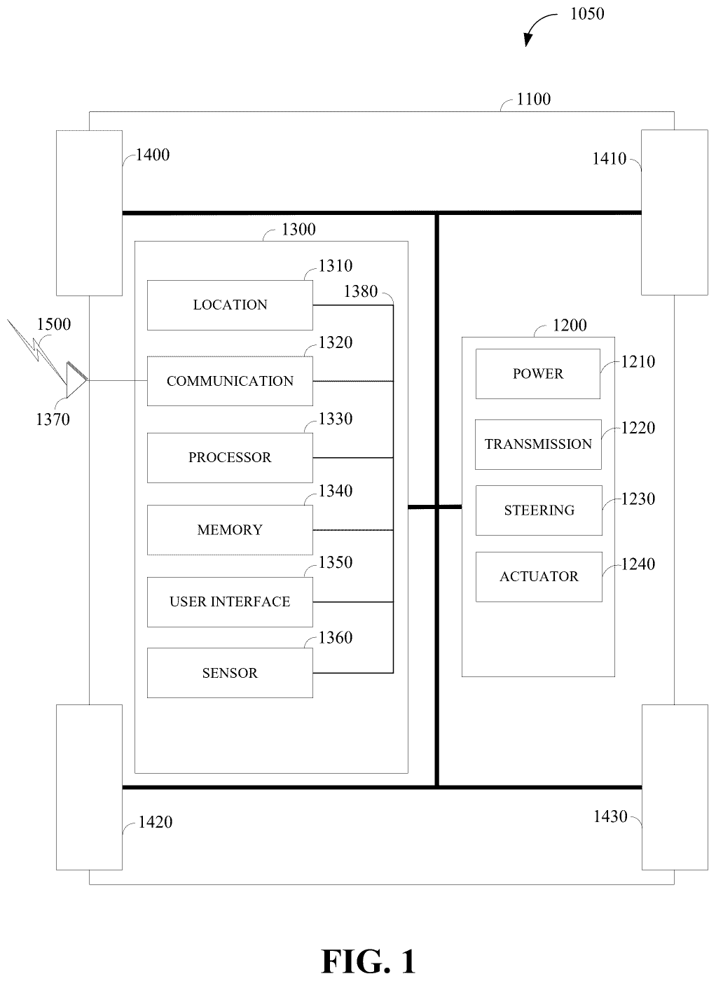

FIG. 1 is a diagram of an example of a vehicle 1050 in which the aspects, features, and elements disclosed herein may be implemented. The vehicle 1050 may include a chassis 1100, a powertrain 1200, a controller 1300, wheels 1400/1410/1420/1430, or any other element or combination of elements of a vehicle. Although the vehicle 1050 is shown as including four wheels 1400/1410/1420/1430 for simplicity, any other propulsion device or devices, such as a propeller or tread, may be used. In FIG. 1, the lines interconnecting elements, such as the powertrain 1200, the controller 1300, and the wheels 1400/1410/1420/1430, indicate that information, such as data or control signals, power, such as electrical power or torque, or both information and power, may be communicated between the respective elements. For example, the controller 1300 may receive power from the powertrain 1200 and communicate with the powertrain 1200, the wheels 1400/1410/1420/1430, or both, to control the vehicle 1050, which can include accelerating, decelerating, steering, or otherwise controlling the vehicle 1050.

The powertrain 1200 includes a power source 1210, a transmission 1220, a steering unit 1230, a vehicle actuator 1240, or any other element or combination of elements of a powertrain, such as a suspension, a drive shaft, axles, or an exhaust system. Although shown separately, the wheels 1400/1410/1420/1430 may be included in the powertrain 1200. A braking system may be included in the vehicle actuator 1240.

The power source 1210 may be any device or combination of devices operative to provide energy, such as electrical energy, chemical energy, or thermal energy. For example, the power source 1210 includes an engine, such as an internal combustion engine, an electric motor, or a combination of an internal combustion engine and an electric motor, and is operative to provide energy as a motive force to one or more of the wheels 1400/1410/1420/1430. In some embodiments, the power source 1210 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 receives energy from the power source 1210 and transmits the energy to the wheels 1400/1410/1420/1430 to provide a motive force. The transmission 1220 may be controlled by the controller 1300, the vehicle actuator 1240 or both. The steering unit 1230 may be controlled by the controller 1300, the vehicle actuator 1240, or both and controls the wheels 1400/1410/1420/1430 to steer the vehicle. The vehicle actuator 1240 may receive signals from the controller 1300 and may actuate or control the power source 1210, the transmission 1220, the steering unit 1230, or any combination thereof to operate the vehicle 1050.

In some embodiments, the controller 1300 includes a location unit 1310, an electronic communication unit 1320, a processor 1330, a memory 1340, a user interface 1350, a sensor 1360, an electronic communication interface 1370, or any combination thereof. Although shown as a single unit, any one or more elements of the controller 1300 may be integrated into any number of separate physical units. For example, the user interface 1350 and processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof can be integrated in one or more electronic units, circuits, or chips.

In some embodiments, the processor 1330 includes any device or combination of devices capable of manipulating or processing a signal or other information now existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more an application-specific integrated circuits (ASICs), one or more field-programmable gate arrays (FPGAs), one or more programmable logic arrays (PLAs), one or more programmable logic controllers (PLCs), one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

In some embodiments, the processor 1330 may be configured to execute instructions including instructions for remote operation which may be used to operate the vehicle 1050 from a remote location including a data-processing center. The instructions for remote operation may be stored in the vehicle 1050 or received from an external source such as a traffic management center, or server computing devices, which may include cloud-based server computing devices. The processor 1330 may be configured to execute instructions for following a projected path as described herein.

The memory 1340 may include any tangible non-transitory computer-usable or computer-readable medium, capable of, for example, containing, storing, communicating, or transporting machine readable instructions or any information associated therewith, for use by or in connection with the processor 1330. The memory 1340 is, for example, one or more solid state drives, one or more memory cards, one or more removable media, one or more read only memories, one or more random access memories, one or more solid-state drives, one or more disks, including a hard disk, a floppy disk, an optical disk, a magnetic or optical card, or any type of non-transitory media suitable for storing electronic information, or any combination thereof.

The electronic communication interface 1370 may be a wireless antenna, as shown, a wired communication port, an optical communication port, or any other wired or wireless unit capable of interfacing with a wired or wireless electronic communication medium 1500.

The electronic communication unit 1320 may be configured to transmit or receive signals via the wired or wireless electronic communication medium 1500, such as via the electronic communication interface 1370. Although not explicitly shown in FIG. 1, the electronic communication unit 1320 is configured to transmit, receive, or both via any wired or wireless communication medium, such as radio frequency (RF), ultraviolet (UV), visible light, fiber optic, wire line, or a combination thereof. Although FIG. 1 shows a single one of the electronic communication unit 1320 and a single one of the electronic communication interface 1370, any number of communication units and any number of communication interfaces may be used. In some embodiments, the electronic communication unit 1320 can include a dedicated short-range communications (DSRC) unit, a wireless safety unit (WSU), IEEE 802.11p (WiFi-P), a cellular communication unit such as a long-term evolution (LTE) or 5G transceiver, or a combination thereof.

The location unit 1310 may determine geolocation information, including but not limited to longitude, latitude, elevation, direction of travel, or speed, of the vehicle 1050. For example, the location unit includes a global navigation satellite system (GNSS) unit (e.g., a global positioning system (GPS) unit), a wide area augmentation system (WAAS) enabled National Marine-Electronics Association (NMEA) unit, a radio triangulation unit, or a combination thereof. The location unit 1310 can be used to obtain information that represents, for example, a current heading of the vehicle 1050, a current position of the vehicle 1050 in two or three dimensions, a current angular orientation of the vehicle 1050, or a combination thereof.

The user interface 1350 may include any unit capable of being used as an interface by a person, including any of a virtual keypad, a physical keypad, a touchpad, a display, a touchscreen, a speaker, a microphone, a video camera, a sensor, and a printer. The user interface 1350 may be operatively coupled with the processor 1330, as shown, or with any other element of the controller 1300. Although shown as a single unit, the user interface 1350 can include one or more physical units. For example, the user interface 1350 includes an audio interface for performing audio communication with a person, and a touch display for performing visual and touch based communication with the person.

The sensor 1360 may include one or more sensors, such as an array of sensors, which may be operable to provide information that may be used to control the vehicle. The sensor 1360 can provide information regarding current operating characteristics of the vehicle or its surrounding. The sensors 1360 include, for example, a speed sensor, acceleration sensors, a steering angle sensor, traction-related sensors, braking-related sensors, or any sensor, or combination of sensors, that is operable to report information regarding some aspect of the current dynamic situation of the vehicle 1050.

In some embodiments, the sensor 1360 may include sensors that are operable to obtain information regarding the physical environment within or surrounding the vehicle 1050. With regard to within the vehicle 1050, e.g., the in-cabin environment, one or more sensors may detect objects within the vehicle, such as groceries, electronic devices, pets, people, in-vehicle controls, and so on. With respect to surrounding the vehicle, one or more sensors may detect road geometry and obstacles, such as fixed obstacles, vehicles, cyclists, and pedestrians. In some embodiments, the sensor 1360 can be or include one or more still or video cameras, laser-sensing systems, infrared-sensing systems, acoustic-sensing systems, or any other suitable type of on-vehicle environmental sensing device, or combination of devices, now known or later developed. In some embodiments, the sensor 1360 and the location unit 1310 are combined.

Although not shown separately, the vehicle 1050 may include a trajectory controller. For example, the controller 1300 may include a trajectory controller. The trajectory controller may be operable to obtain information describing a current state of the vehicle 1050 and a route planned for the vehicle 1050, and, based on this information, to determine and optimize a trajectory for the vehicle 1050. In some embodiments, the trajectory controller outputs signals operable to control the vehicle 1050 such that the vehicle 1050 follows the trajectory that is determined by the trajectory controller. For example, the output of the trajectory controller can be an optimized trajectory that may be supplied to the powertrain 1200, the wheels 1400/1410/1420/1430, or both. In some embodiments, the optimized trajectory can control inputs such as a set of steering angles, with each steering angle corresponding to a point in time or a position. In some embodiments, the optimized trajectory can be one or more paths, lines, curves, or a combination thereof.

One or more of the wheels 1400/1410/1420/1430 may be a steered wheel, which is pivoted to a steering angle under control of the steering unit 1230, a propelled wheel, which is torqued to propel the vehicle 1050 under control of the transmission 1220, or a steered and propelled wheel that steers and propels the vehicle 1050.

A vehicle may include units, or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

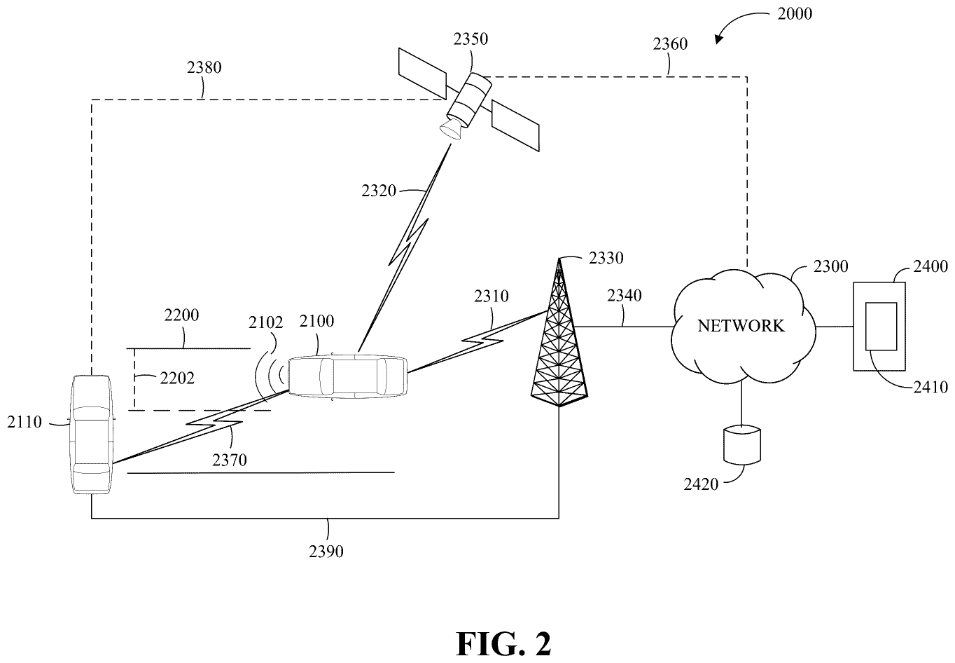

FIG. 2 is a diagram of an example of a portion of a vehicle transportation and communication system 2000 in which the aspects, features, and elements disclosed herein may be implemented. The vehicle transportation and communication system 2000 includes a vehicle 2100, such as the vehicle 1050 shown in FIG. 1, and one or more external objects, such as an external object 2110, which can include any form of transportation, such as the vehicle 1050 shown in FIG. 1, a pedestrian, cyclist, as well as any form of a structure, such as a building. The vehicle 2100 may travel via one or more portions of a transportation network 2200, and may communicate with the external object 2110 via one or more of an electronic communication network 2300. Although not explicitly shown in FIG. 2, a vehicle may traverse an area that is not expressly or completely included in a transportation network, such as an off-road area. In some embodiments the transportation network 2200 may include one or more of a vehicle detection sensor 2202, such as an inductive loop sensor, which may be used to detect the movement of vehicles on the transportation network 2200.

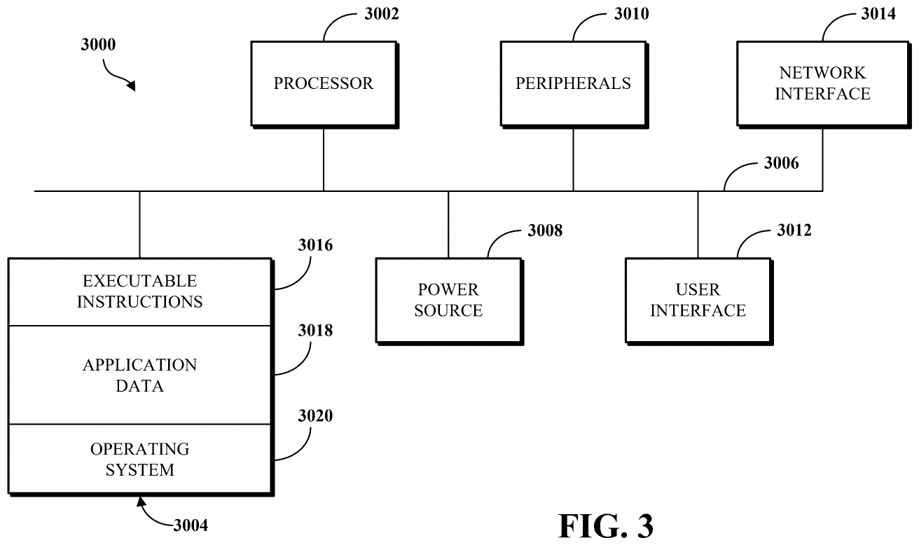

The electronic communication network 2300 may be a multiple-access system that provides for communication, such as voice communication, data communication, video communication, messaging communication, or a combination thereof, between the vehicle 2100, the external object 2110, and a data-processing center 2400. For example, the vehicle 2100 or the external object 2110 may send information to, or receive information from, the data-processing center 2400 or a database server 2420, via the electronic communication network 2300, such as information representing the transportation network 2200. The data-processing center 2400 includes a computing apparatus 2410, that includes some or all of the features of the computing device 3000 shown in FIG. 3. In some implementations, the data-processing center 2400 includes the database server 2420. The database server 2420 is configured for storing data, and it may be implemented by a suitable computer storage medium.

The data-processing center 2400 can monitor and coordinate the movement of vehicles, including autonomous vehicles. The data-processing center 2400 may monitor the state or condition of vehicles, such as the vehicle 2100, and external objects, such as the external object 2110. The data-processing center 2400 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the data-processing center 2400 can establish remote control over one or more vehicles, such as the vehicle 2100, or external objects, such as the external object 2110. In this way, the data-processing center 2400 may tele-operate the vehicles or external objects from a remote location. The computing apparatus 2410 may exchange (send or receive) state data with vehicles, external objects, or computing devices such as the vehicle 2100, the external object 2110, or the database server 2420, via a wireless communication link such as the wireless communication link 2380 or a wired communication link such as the wired communication link 2390.

In some embodiments, the vehicle 2100 or the external object 2110 communicates via the wired communication link 2390, a wireless communication link 2310/2320/2370, or a combination of any number or types of wired or wireless communication links. For example, as shown, the vehicle 2100 or the external object 2110 communicates via a terrestrial wireless communication link 2310, via a non-terrestrial wireless communication link 2320, or via a combination thereof. In some implementations, a terrestrial wireless communication link 2310 includes an Ethernet link, a serial link, a Bluetooth link, an infrared (IR) link, an ultraviolet (UV) link, or any link capable of providing for electronic communication.

A vehicle, such as the vehicle 2100, or an external object, such as the external object 2110, may communicate with another vehicle, external object, or the data-processing center 2400. For example, a host, or subject, vehicle 2100 may receive one or more automated inter-vehicle messages, such as a basic safety message (BSM), from the data-processing center 2400, via a direct communication link 2370, or via an electronic communication network 2300. For example, data-processing center 2400 may broadcast the message to host vehicles within a defined broadcast range, such as three hundred meters, or to a defined geographical area. In some embodiments, the vehicle 2100 receives a message via a third party, such as a signal repeater (not shown) or another remote vehicle (not shown). In some embodiments, the vehicle 2100 or the external object 2110 transmits one or more automated inter-vehicle messages periodically based on a defined interval, such as one hundred milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system state data, throttle information, steering wheel angle information, or vehicle routing information, or vehicle operating state information, such as vehicle size information, headlight state information, turn signal information, wiper state data, transmission information, or any other information, or combination of information, relevant to the transmitting vehicle state. For example, transmission state information indicates whether the transmission of the transmitting vehicle is in a neutral state, a parked state, a forward state, or a reverse state.

In some embodiments, the vehicle 2100 communicates with the electronic communication network 2300 via an access point 2330. The access point 2330, which may include a computing device, may be configured to communicate with the vehicle 2100, with the electronic communication network 2300, with the data-processing center 2400, or with a combination thereof via wired or wireless communication links 2310/2340. For example, an access point 2330 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 2100 may communicate with the electronic communication network 2300 via a satellite 2350, or other non-terrestrial communication device. The satellite 2350, which may include a computing device, may be configured to communicate with the vehicle 2100, with the electronic communication network 2300, with the data-processing center 2400, or with a combination thereof via one or more communication links 2320/2360. Although shown as a single unit, a satellite can include any number of interconnected elements.

The electronic communication network 2300 may be any type of network configured to provide for voice, data, or any other type of electronic communication. For example, the electronic communication network 2300 includes a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, an electronic communication network can include any number of interconnected elements.

In some embodiments, the vehicle 2100 communicates with the data-processing center 2400 via the electronic communication network 2300, access point 2330, or satellite 2350. The data-processing center 2400 may include one or more computing devices, which are able to exchange (send or receive) data from: vehicles such as the vehicle 2100; external objects including the external object 2110; or storage devices such as the database server 2420.

In some embodiments, the vehicle 2100 identifies a portion or condition of the transportation network 2200. For example, the vehicle 2100 may include one or more on-vehicle sensors 2102, such as the sensor 1360 shown in FIG. 1, which includes a speed sensor, a wheel speed sensor, a camera, a gyroscope, an optical sensor, a laser sensor, a radar sensor, a sonic sensor (e.g., a microphone or acoustic sensor), a compass, or any other sensor or device or combination thereof capable of determining or identifying a portion or condition of the transportation network 2200.

The vehicle 2100 may traverse one or more portions of the transportation network 2200 using information communicated via the electronic communication network 2300, such as information representing the transportation network 2200, information identified by one or more on-vehicle sensors 2102, or a combination thereof. The external object 2110 may be capable of all or some of the communications and actions described above with respect to the vehicle 2100.

For simplicity, FIG. 2 shows the vehicle 2100 as the host vehicle, the external object 2110, the transportation network 2200, the electronic communication network 2300, and the data-processing center 2400. However, any number of vehicles, networks, or computing devices may be used. In some embodiments, the vehicle transportation and communication system 2000 includes devices, units, or elements not shown in FIG. 2. Although the vehicle 2100 or external object 2110 is shown as a single unit, a vehicle can include any number of interconnected elements.

Although the vehicle 2100 is shown communicating with the data-processing center 2400 via the electronic communication network 2300, the vehicle 2100 (and external object 2110) may communicate with the data-processing center 2400 via any number of direct or indirect communication links. For example, the vehicle 2100 or external object 2110 may communicate with the data-processing center 2400 via a direct communication link, such as a Bluetooth communication link. Although, for simplicity, FIG. 2 shows one of the transportation network 2200, and one of the electronic communication network 2300, any number of networks or communication devices may be used. The vehicle 2100 (and external object 2110) can be monitored or coordinated by the data-processing center 2400, can be operated autonomously or by a human driver, and can exchange (send and receive) vehicle data relating to the state or condition of the vehicle and its surroundings including any of vehicle velocity (e.g., vehicle speed and vehicle trajectory, or heading); vehicle location; vehicle operational state; vehicle destination; vehicle route; vehicle sensor data; external object velocity; external object location, and so on.

FIG. 3 shows a block diagram of an example of a computing device 3000 in which certain aspects, features, and elements disclosed herein may be implemented. The computing device 3000 includes components or units, such as a processor 3002, a memory 3004, a bus 3006, a power source 3008, peripherals 3010, a user interface 3012, a network interface 3014, other suitable components, or a combination thereof. One or more of the memory 3004, the power source 3008, the peripherals 3010, the user interface 3012, or the network interface 3014 can communicate with the processor 3002 via the bus 3006.

The processor 3002 is a central processing unit, such as a microprocessor, and can include single or multiple processors having single or multiple processing cores. Alternatively, the processor 3002 can include another type of device, or multiple devices, configured for manipulating or processing information. For example, the processor 3002 can include multiple processors interconnected in one or more manners, including hardwired or networked. The operations of the processor 3002 can be distributed across multiple devices or units that can be coupled directly or across a local area or other suitable type of network. The processor 3002 can include a cache, or cache memory, for local storage of operating data or instructions.

The memory 3004 includes one or more memory components, which may each be volatile memory or non-volatile memory. For example, the volatile memory can be random access memory (RAM) (e.g., a DRAM module, such as DDR SDRAM). In another example, the non-volatile memory of the memory 3004 can be a disk drive, a solid state drive, flash memory, or phase-change memory. In some implementations, the memory 3004 can be distributed across multiple devices. For example, the memory 3004 can include network-based memory or memory in multiple clients or servers performing the operations of those multiple devices.

The memory 3004 can include data for immediate access by the processor 3002. For example, the memory 3004 can include executable instructions 3016, application data 3018, and an operating system 3020. The executable instructions 3016 can include one or more application programs, which can be loaded or copied, in whole or in part, from non-volatile memory to volatile memory to be executed by the processor 3002. For example, the executable instructions 3016 can include instructions for performing techniques of this disclosure. In some implementations, the application data 3018 can include functional programs, such as a computational programs, analytical programs, database programs, and so on. The operating system 3020 can be, for example, Microsoft Windows®, Mac OS X®, or Linux®; an operating system for a mobile device, such as a smartphone or tablet device; or an operating system for a non-mobile device, such as a mainframe computer.

The power source 3008 provides power to the computing device 3000. For example, the power source 3008 can be an interface to an external power distribution system. In another example, the power source 3008 can be a battery, such as where the computing device 3000 is a mobile device or is otherwise configured to operate independently of an external power distribution system. In some implementations, the computing device 3000 may include or otherwise use multiple power sources. In some such implementations, the power source 3008 can be a backup battery.

The peripherals 3010 may include one or more sensors, detectors, or other devices configured for monitoring the computing device 3000 or the environment around the computing device 3000. For example, the peripherals 3010 can include a geolocation component, such as a GNSS location unit (e.g., GPS). In another example, the peripherals can include a temperature sensor for measuring temperatures of components of the computing device 3000, such as the processor 3002. In some implementations, the computing device 3000 can omit the peripherals 3010.

The user interface 3012 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 3014 provides a connection or link to a network (e.g., the electronic communication network 2300 shown in FIG. 2). The network interface 3014 can be a wired network interface or a wireless network interface. The computing device 3000 can communicate with other devices via the network interface 3014 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 3000 can communicate with a database server, such as the database server 2420 of FIG. 2.

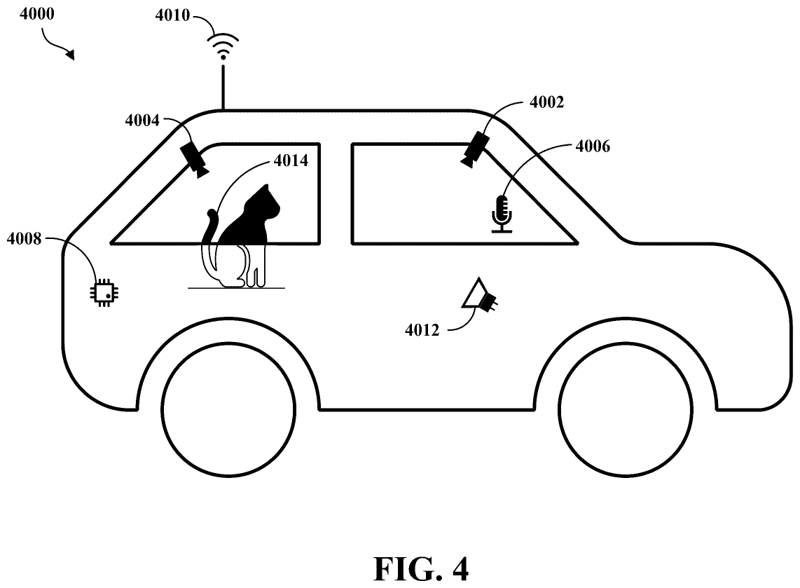

FIG. 4 is a diagram of an example of a system, for responding to queries about in-cabin objects, that is integrated with a vehicle 4000. The vehicle 4000 may be, for example, the vehicle 1050 of FIG. 1.

The vehicle 4000 includes a camera 4002 and a camera 4004, each of which may be an instance of the sensor 1360 of FIG. 1, and possibly additional cameras or other sensors, for sensing, detecting, or observing a cabin environment of the vehicle 4000 and objects therein, such as the object 4014. In the example of FIG. 4, the camera 4002 observes a front-seat area of the cabin, and the camera 4004 observes a rear-seat area of the cabin. In some implementations, additional cameras may observe, areas that may be occluded or separated from the passenger cabin of the vehicle, such as a separate trunk space, where such occluded or separated areas may also be considered as part of the cabin of the vehicle 4000.

The vehicle 4000 includes a microphone 4006, which may be an instance of the sensor 1360 of FIG. 1, for detecting spoken queries from a user, such as questions or commands from a driver or passenger of the vehicle 4000. In some implementations, the microphone 4006 may be a directional microphone, such as an array of microphones, for determining a location of the user within the cabin of the vehicle 4000. In some implementations, the location of the user may be utilized by the system for providing improved, e.g., location-based, responses to the user's queries. For example, a user who fails to see a water bottle in the front passenger seat of the vehicle may ask the system if there is a water bottle somewhere in the vehicle. If the user's voice emanates from the driver's seat as determined by the microphone 4006, the system may respond that the water bottle is on the seat next to him; if the user's voice emanates from a rear passenger seat as determined by the microphone 4006, the system may respond that the water bottle is on the seat in front of him. Such location-based responses may also utilize the location of the user as determined by the camera 4002, the camera 4004, or other sensors such as pressure or temperature sensors in the seats of the vehicle.

The vehicle 4000 includes a computing device 4008, which may be an instance of the computing device 3000 of FIG. 3. The computing device 4008 is configured to execute several tasks, such as processing images captured by the camera 4002, by the camera 4004, and by other sensors; processing audio captured by the microphone 4006; and communicating with additional computing devices, such as cloud-based computing or storage devices, for executing additional tasks, such as natural language processing (NLP) tasks and LMM tasks that may be too computationally intensive to be performed locally by the computing device 4008. One or more of these tasks are described more fully below. The additional computing devices may be part of a data-processing center, such as the data processing center 2400 of FIG. 2. The computing device 4008 may utilize a communication interface 4010, such as a wireless antenna, for unidirectional or bidirectional communication to the additional computing devices. The communication interface 4010 may be an instance of the communication interface 1370 of FIG. 3, and the communication may occur via a network, such as the network 2300 of FIG. 2.

The vehicle 4000 includes a speaker 4012 (or multiple such speakers), which may be an instance of the user interface 1350 of FIG. 1. The speaker 4012 is configured to provide audible responses to user queries, for example, as AI-generated spoken language. In some implementations, the speaker 4012 and the microphone 4006 may be components of an in-vehicle infotainment system (IVI).

In some implementations, the camera 4002 and the camera 4004 may be activated, e.g., begin capturing and/or recording video, in response to a trigger. The trigger may be a suitable event, such as the system detecting a mobile device or key fob entering the cabin environment by a communication channel between the mobile device or the key fob and the vehicle 4000; the system detecting an occupant entering the cabin environment by the camera 4002 or the camera 4004 or by an in-cabin proximity sensor; the system detecting an occupant speaking by the microphone 4006; the system detecting the vehicle 4000 waking from a dormant state, for example, via the computing device 4008; or the system detecting the vehicle 4000 departing from an origin or arriving at a destination by a global navigation satellite system (GNSS). In the case of the system detecting an occupant entering the cabin environment by the camera 4002 or the camera 4004, the camera 4002 and/or the camera 4004 may be, for example, in a low-power or stand-by state prior to the trigger, where the camera 4002 and/or the camera 4004 wake up periodically to capture one or a few video frames at a low resolution that is sufficient to detect whether an occupant has entered the vehicle 4000. Upon the trigger, the camera 4002 and/or the camera 4004 may begin capturing, for example, higher resolution video frames at a higher frame rate than compared to the low-power or stand-by state.

Following the trigger and subsequent capturing of video frames, the system begins generating captions for one or more of the frames. A caption comprises a text-based description of a frame. A sequence of captions of a sequence of frames, where the sequence need not include every frame captured by a camera, may be referred to herein as a history of captions. The system utilizes an LMM to generate the captions, where the LMM may be executed by one or more computing devices external to the vehicle 4000, such as a computing apparatus 2410 in the data-processing center 2400 of FIG. 2. In such case, the computing device 4008 of the vehicle 4000 causes the frames to be transmitted to the one or more external computing devices via the communication interface 4010.

Also following the trigger, the system listens for a query from a user of the vehicle 4000 via the microphone 4006. The query may be formulated in a suitable manner, such as in complete or incomplete sentences. The system utilizes NLP to processes voice audio captured by the microphone 4006 into text that may be referred to herein as a textual prompt, a text-based prompt, or simply a prompt (for use by the LMM, as described below), where the NLP processing may be executed by one or more computing devices external to the vehicle 4000, such as a computing apparatus 2410 in the data-processing center 2400 of FIG. 2. In such case, the computing device 4008 of the vehicle 4000 causes the captured voice audio to be transmitted to the one or more external computing devices via the communication interface 4010.

In some instances, the prompt created from the query may be self-contained, such that the system can understand the query without additional input. For example, “What is my cat doing in the backseat?” or “Where is my cell phone?” are self-contained queries. In other instances, the prompt created from the query may not be self-contained, such that the system may require additional information. For example, “What does this button do?” or “What was that noise?” are not self-contained queries. However, one benefit of the system that utilizes an LMM is that the system can incorporate additional, e.g., multi-modal, information into the query, notably, information captured by a camera or detected by a sensor. Thus, when a user points to a button and asks, “What does this button do?”, the system might determine what button the user is likely pointing to based on one or more frames of video captured by cameras or based on data collected by proximity or touch sensors, at or around the time the user asked the question. Similarly, when a user asks, “What was that noise?”, the system can determine what noise the user is likely referring to based background noise captured by a microphone, based on data collected by an accelerometer sensor, or based on audio playing on the speakers, at or around the time the user asked the question.

After the system converts the query into the text-based prompt, the system generates a response to the prompt via the LMM based on at least one caption, e.g., based on the history of captions. In other words, the LMM receives as input the prompt and at least one caption, and determined therefrom, a response to the prompt. As explained above, the LMM may be executed by one or more computing devices external to the vehicle 4000, such as a computing apparatus 2410 in the data-processing center 2400 of FIG. 2. In such case, the computing device 4008 of the vehicle 4000 causes the prompt to be transmitted to the one or more external computing devices via the communication interface 4010. In some implementations, the NLP processing and the LMM may be executed by the same computing devices, in which case transmission of the prompt may be unnecessary.

For user safety and/or convenience, the system may convert the response, which is text-based, to speech, via a suitable text-to-speech technique, and cause a speaker, such as the speaker 4012, to output the response via audio. The text-to-speech technique may be executed by the computing device 4008 and or by one or more computing devices external to the vehicle 4000, such as a computing apparatus 2410 in the data-processing center 2400 of FIG. 2.

In the implementation described above, the LMM generates a history of captions for video frames and used this history to generate the response to the prompt. In some implementations, the captions are generated as the video frames are captured. In such implementations, the history of captions is stored to a memory and the video frames need not be stored to the memory, which can provide for a system that utilizes memory efficiently. However, in some implementations, the video frames may also be stored to the memory, such that the system may recaption one or more frames based on, for example, the user's query. In other implementations, the video frames may be stored to the memory as they are captured and the captions may be generated later, for example, when a user provides a query. Because frames typically require greater storage capacity than captions do, it may be advantageous to store only frames that provide the most useful information for the system to respond to users' queries. As a simple example, the system may store only every n^{th} frame, where n>1. Alternatively, the system may store only frames that depict a non-trivial change compared to a previous frame, such as when there is some movement or motion in the scene captured by the frames.

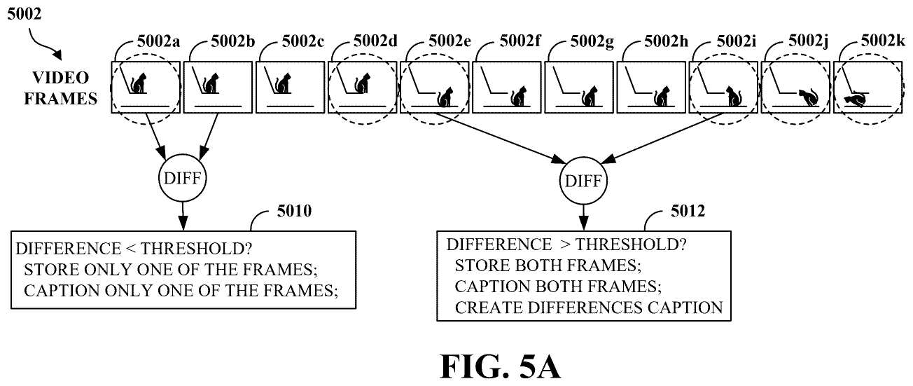

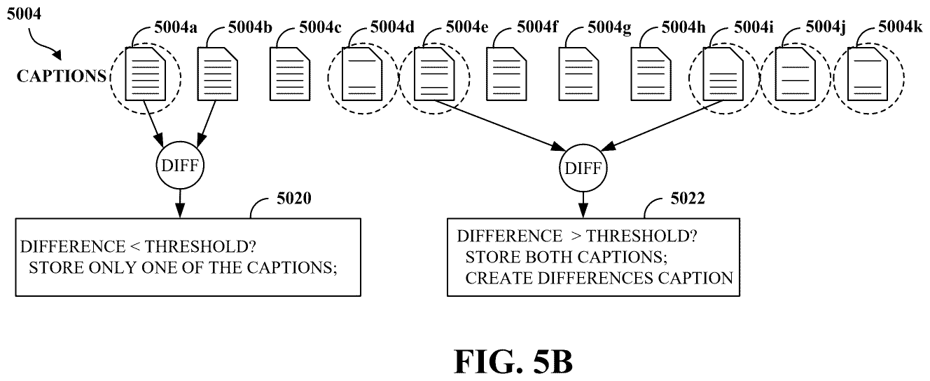

FIG. 5A is a diagram of an example of a sequence of video frames 5002 captured by one or more cameras of a system for responding to queries about in-cabin objects, such as the camera 4002 and the camera 4004 of FIG. 4. The content captured in some frames, such as frames 5002a, 5002b, 5002c, and 5002d, may be quite similar to one another, for example, if there is no movement or motion in the scene as captured by the camera or cameras, and the content captured in other frames, such as frames 5002h, 5002i, 5002j, and 5002k, may be quite different. As indicated in FIG. 5A, the system may compare frames to determine a difference therebetween, and perform tasks based on whether that difference is greater than a threshold. Such difference may be achieved using suitable methods, such as those utilizing mean square error (MSE), histograms, and point-by-point detection.

As indicated in box 5012, if the difference between an earlier frame 5002e and a later frame 5002i is greater than the threshold, which may indicate something in the scene has moved or changed, then the system may store to a memory both frames 5002e and 5002i as indicated by the dashed circles, and/or the system may generate (and store to the memory) a caption both frames 5002e and 5002i; and or the system may generate (and store to the memory) a caption describing the differences between the frames 5002e and 5002i, for later processing. If, however, as indicated in box 5010, the difference between an earlier frame 5002a and a later frame 5002b is less than (or equal to) the threshold, then the system may opt not to save one of the frames, for example, the later frame 5002b as indicated by the absence of a dashed circle, and the system may opt not to generate (and store to the memory) a caption for one of the frames, for example, the later frame 5002b, to preserve storage memory because the content captured in the later frame 5002b is seemingly redundant to the earlier frame 5002a.

While captions typically require less storage capacity than frames do, it may nonetheless be advantageous to store only select captions rather than storing a caption for every frame. FIG. 5B is a diagram of an example of a sequence of captions of a set of video frames, such as the video frames 5002 of FIG. 5B. The set of frames may be a consecutive sequence of frames or it may be, for example, every n^{th} frame captured by one or more cameras, such as the camera 4002 or the camera 4004 of FIG. 4. In some implementations, the system may store to memory every n^{th} frame and every m^{th} caption, where n≠m (e.g., the system may store frames and captions at different rates). Some captions may be very similar to one another, for example, if there was no movement or motion in the scene as captured by the camera or cameras. As indicated in FIG. 5B, the system may compare captions to determine a difference therebetween, and perform tasks based on whether that difference is greater than a threshold. Such difference may be achieved using suitable methods, such as by sequence comparison.

As indicated in box 5022, if the difference between an earlier caption 5004e and a later caption 5004i is greater than the threshold, which may indicate something in the scene has moved or changed, then the system may save both captions 5004e and 5004i, and/or the system may generate a caption that describes differences between the caption 5004e and the caption 5004i) for later processing. If, however, as indicated in box 5020, the difference between an earlier caption 5004a and a later caption 5004b is less than (or equal to) the threshold, then the system may opt not to save one of the captions, for example, the later caption 5004b, to preserve storage memory because the content captured in the later caption 5004b is seemingly redundant to the earlier caption 5004a.

The storage of frames and/or captions to memory may be achieved via local memory within the vehicle 4000, such as memory integral to or coupled with the computing device 4008, and/or via remote memory, such as a cloud storage device. In some implementations, the memory may be configured as a circular buffer, such that memory locations get overwritten once the memory fills up.

As mentioned above, the system may generate (and store) a caption that describes differences between the two (or more) frames or between two or more captions, either or which may be referred to herein as a differences caption. Differences captions can be helpful for the system to provide accurate responses to queries about in-cabin objects. For example, referring again to FIG. 5A, the frame 5002e shows a cat sitting on the floor in front of the back seat facing forward, and the frame 5002i shows a cat sitting on the floor in front of the back seat facing backward. While the graphical differences in the frames 5002e and 5002i may exceed the threshold, the LMM may caption both frames 5002e and 5002i as “cat sitting on the floor in front of the back seat.” However, by further generating a differences caption between frame 5002e and 5002i, it may be possible to more accurately describe how the state of the cat has changed between the frames 5002e and 5002i, for example, as “the cat has turned around from facing forward to facing backward.” Such additional differences caption, which is incorporated into the history of captions, enables the system to more accurately response to users' queries, such as “What is my cat doing in the back seat?”

In some implementations, the system may partition, or segment, a given frame into subframes via suitable image processing methods, and generate a caption for each subframe as described earlier, such that a given frame has multiple captions in the history of captions. For example, the system may partition a given frame into a foreground subframe and a background subframe, and the system may generate a first caption for the foreground and a second caption for the background. Image partitioning, or segmentation, and captioning can be advantageous, for example, by causing more descriptive or detailed captions to be generated by the LMM.

For simplicity of explanation, each technique, or process, is depicted and described herein as a series of steps or operations. However, the steps or operations of the techniques in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The technique 6000 described below is a technique for responding to queries about in-cabin objects. This technique may be implemented by a system whose components may be internal and/or external to a vehicle, such as the computing device 4008 of FIG. 4 and a computing apparatus 2410 of the data-processing center 2400 of FIG. 2, as well as one or more mobile computing devices, such as smartphones, smart watches, and tablets.

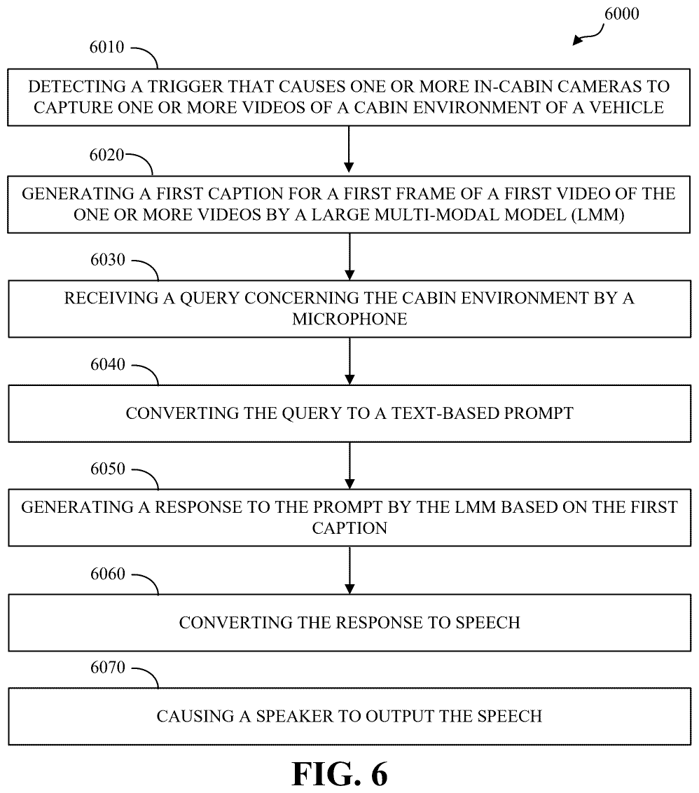

FIG. 6 is a flowchart of an example of a technique 6000 for detecting a trigger that causes one or more in-cabin cameras to capture one or more videos of a cabin environment of a vehicle.

The step 6010 comprises detecting a trigger that causes one or more in-cabin cameras to capture one or more videos of a cabin environment of a vehicle. The vehicle may be the vehicle 4000 of FIG. 4 and the one or more cameras may be the camera 4002 and the camera 4004 of FIG. 4. In some implementations, an individual one of the one or more in-cabin cameras comprises in infrared camera.

In some implementations, detecting the trigger comprises at least one of: detecting a mobile device or key fob entering the cabin environment by a communication channel between the mobile device or the key fob and the vehicle, such as by a communication channel enabled by the communication interface 4010 of FIG. 4; detecting an occupant entering the cabin environment by the one or more in-cabin cameras or by an in-cabin proximity sensor, such as an instance of the sensor 1360 of FIG. 1; detecting an occupant speaking by an in-cabin microphone, such as the microphone 4006 of FIG. 4; detecting the vehicle waking from a dormant state by a processor of the vehicle, such as by the computing device 4008 of FIG. 4; or detecting the vehicle departing from an origin or arriving at a destination by GNSS, such as an instance of the location unit 1310 of FIG. 1.

The step 6020 comprises generating a first caption for a first frame of a first video of the one or more videos by an LMM. The first frame may be a video frame 5002 of FIG. 5 and the first caption may be a caption 5004 of FIG. 5.

In some implementations, the technique further comprises storing the first caption to a memory comprising at least one of: an in-vehicle storage device; or a cloud storage device. In some implementations, the technique further comprises storing the first frame to a memory comprising at least one of: an in-vehicle storage device; or a cloud storage device.

In some implementations, the technique further comprises partitioning the first frame into a plurality of subframes; and generating a plurality of first captions for the plurality of subframes by the LMM. In some implementations, the technique further comprises generating a plurality of first captions for a plurality of first frames of the first video by the LMM; and storing at least one of the plurality of first captions or the plurality of first frames to a memory configured as a circular buffer. In some implementations, the technique further comprises generating a plurality of first captions for a plurality of first frames of the first video by the LMM; storing the plurality of first captions to a first memory configured as a circular buffer at a first rate; and storing the plurality of first frames to either the first memory or a second memory configured as a circular buffer at a second rate that differs from the first rate.

In some implementations, the technique further comprises generating a plurality of first captions for a plurality of first frames of the first video by the LMM; storing individual ones of the plurality of first captions to a first memory at a first rate; and storing individual ones of the plurality of first frames to either the first memory or a second memory at a second rate that differs from the first rate.

The step 6030 comprises receiving a query concerning the cabin environment by a microphone. The microphone may be the microphone 4006 of FIG. 4. In some implementations, the microphone comprises at least one of: an in-cabin microphone; or a microphone of a mobile device.

The step 6040 comprises converting the query to a text-based prompt. Converting the query to a text-based prompt may be performed via NLP, where the NLP processing may be executed by the computing device 4008 of FIG. 4 and/or by one or more computing devices external to the vehicle, such as the computing apparatus 2410 in the data-processing center 2400 of FIG. 2.

The step 6050 comprises generating a response to the prompt by the LMM based on the first caption. The LMM may be executed by the computing device 4008 of FIG. 4 and/or by one or more computing devices external to the vehicle, such as a computing apparatus 2410 in the data-processing center 2400 of FIG. 2. In some implementations, the technique further comprises generating the response to the prompt by the LMM based on the first frame.

In some implementations, the technique further comprises generating a second caption for a second frame of either the first video or of a second video of the one or more videos by the LMM; determining a similarity between the first caption and the second caption; in response to the similarity exceeding a predefined threshold, discarding the first caption and storing the second caption to a memory.

In some implementations, the technique further comprises generating a second caption for a second frame of either the first video or of a second video of the one or more videos by the LMM; determining a difference between the first caption and the second caption; in response to the difference exceeding a predefined threshold, generating a description of the difference by the LMM; and generating the response to the prompt by the LMM based on the description.

In some implementations, the technique further comprises determining a similarity between the first frame and a second frame of either the first video or of a second video of the one or more videos; in response to the similarity exceeding a predefined threshold, discarding the first frame and storing the second frame to a memory.

In some implementations, the technique further comprises determining a difference between the first frame and a second frame of either the first video or of a second video of the one or more videos; in response to the difference exceeding a predefined threshold, generating a description of the difference by the LMM; and generating the response to the prompt by the LMM based on the description.

In some implementations, the technique further comprises detecting the trigger that causes one or more in-cabin sensors to collect data for one or more properties of the cabin environment; generating a description of the data for at least one of the one or more properties by the LMM; and generating the response to the prompt by the LMM based on the description.

In some implementations, the technique further comprises detecting the trigger that causes one or more in-cabin sensors to collect data for one or more properties of the cabin environment; generating a description of the data for at least one of the one or more properties by the LMM; storing the first caption and the description to a memory comprising at least one of: an in-vehicle storage device; or a cloud storage device; and generating the response to the prompt by the LMM based on the description.

The step 6060 comprises converting the response to speech.

The step 6070 comprises causing a speaker to output the speech. The speaker may be the speaker 4012 of FIG. 4. In some implementations, the speaker comprises at least one of: an in-cabin speaker; or a speaker of a mobile device.

The above-described techniques can be implemented as a method, a system, and a non-transitory computer-readable medium, for example, as described below.

In an example implementation as a method, the method comprises: detecting a trigger that causes one or more in-cabin cameras to capture one or more videos of a cabin environment of a vehicle; generating a first caption for a first frame of a first video of the one or more videos by a large multi-modal model (LMM); receiving a query concerning the cabin environment by a microphone; converting the query to a text-based prompt; generating a response to the prompt by the LMM based on the first caption; converting the response to speech; and causing a speaker to output the speech.

In some implementations, detecting the trigger comprises at least one of: detecting a mobile device or key fob entering the cabin environment by a communication channel between the mobile device or the key fob and the vehicle; detecting an occupant entering the cabin environment by the one or more in-cabin cameras or by an in-cabin proximity sensor; detecting an occupant speaking by an in-cabin microphone; detecting the vehicle waking from a dormant state by a processor of the vehicle; or detecting the vehicle departing from an origin or arriving at a destination by a global navigation satellite system (GNSS).

In some implementations, the microphone comprises at least one of: an in-cabin microphone; or a microphone of a mobile device.

In some implementations, the speaker comprises at least one of: an in-cabin speaker; or a speaker of a mobile device.

In some implementations, the method further comprises: generating the response to the prompt by the LMM based on the first frame.

In some implementations, the method further comprises: storing the first caption to a memory comprising at least one of: an in-vehicle storage device; or a cloud storage device.

In some implementations, the method further comprises: generating a second caption for a second frame of either the first video or of a second video of the one or more videos by the LMM; determining a similarity between the first caption and the second caption; in response to the similarity exceeding a predefined threshold, discarding the first caption and storing the second caption to a memory.

In some implementations, the method further comprises: generating a second caption for a second frame of either the first video or of a second video of the one or more videos by the LMM; determining a difference between the first caption and the second caption; in response to the difference exceeding a predefined threshold, generating a description of the difference by the LMM; and generating the response to the prompt by the LMM based on the description.

In some implementations, the method further comprises: storing the first frame to a memory comprising at least one of: an in-vehicle storage device; or a cloud storage device.

In some implementations, the method further comprises: determining a similarity between the first frame and a second frame of either the first video or of a second video of the one or more videos; in response to the similarity exceeding a predefined threshold, discarding the first frame and storing the second frame to a memory.

In some implementations, the method further comprises: determining a difference between the first frame and a second frame of either the first video or of a second video of the one or more videos; in response to the difference exceeding a predefined threshold, generating a description of the difference by the LMM; and generating the response to the prompt by the LMM based on the description.

In some implementations, the method further comprises: partitioning the first frame into a plurality of subframes; and generating a plurality of first captions for the plurality of subframes by the LMM.

In some implementations, the method further comprises: generating a plurality of first captions for a plurality of first frames of the first video by the LMM; and storing at least one of the plurality of first captions or the plurality of first frames to a memory configured as a circular buffer.

In some implementations, the method further comprises: generating a plurality of first captions for a plurality of first frames of the first video by the LMM; storing individual ones of the plurality of first captions to a first memory at a first rate; and storing individual ones of the plurality of first frames to either the first memory or a second memory at a second rate that differs from the first rate.

In some implementations, an individual one of the one or more in-cabin cameras comprises in infrared camera.

In some implementations, the method further comprises: detecting the trigger that causes one or more in-cabin sensors to collect data for one or more properties of the cabin environment; generating a description of the data for at least one of the one or more properties by the LMM; and generating the response to the prompt by the LMM based on the description.

In another example implementation as a system, the system comprises one or more memories; and one or more processors configured to execute instructions stored in the one or more memories to: detect a trigger that causes one or more in-cabin cameras to capture one or more videos of a cabin environment of a vehicle; generate a first caption for a first frame of a first video of the one or more videos by a large multi-modal model (LMM); receive a query concerning the cabin environment by a microphone; convert the query to a text-based prompt; generate a response to the prompt by the LMM based on the first caption; convert the response to speech; and cause a speaker to output the speech.

In some implementations, the instructions include instructions to: generate a plurality of first captions for a plurality of first frames of the first video by the LMM; store the plurality of first captions to a first memory configured as a circular buffer at a first rate; and store the plurality of first frames to either the first memory or a second memory configured as a circular buffer at a second rate that differs from the first rate.

In another example implementation as a non-transitory computer-readable medium, the non-transitory computer-readable medium stores instructions operable to cause one or more processors to perform operations comprising: detecting a trigger that causes one or more in-cabin cameras to capture one or more videos of a cabin environment of a vehicle; generating a first caption for a first frame of a first video of the one or more videos by a large multi-modal model (LMM); receiving a query concerning the cabin environment by a microphone; converting the query to a text-based prompt; generating a response to the prompt by the LMM based on the first caption; converting the response to speech; and causing a speaker to output the speech.

In some implementations, the operations further comprise: detecting the trigger that causes one or more in-cabin sensors to collect data for one or more properties of the cabin environment; generating a description of the data for at least one of the one or more properties by the LMM; storing the first caption and the description to a memory comprising at least one of: an in-vehicle storage device; or a cloud storage device; and generating the response to the prompt by the LMM based on the description

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described to allow easy understanding of the disclosure are not limiting. On the contrary, the disclosure covers various modifications and equivalent arrangements included within the scope of the appended claims, which scope is to be accorded the broadest interpretation to encompass all such modifications and equivalent structure as is permitted under the law.

What is claimed is:

1. A method, comprising:
detecting a trigger that causes one or more in-cabin cameras to capture one or more videos of a cabin environment of a vehicle;
generating a first caption for a first frame of a first video of the one or more videos by a large multi-modal model (LMM);
receiving a query concerning the cabin environment by a microphone;
converting the query to a text-based prompt;
generating a response to the prompt by the LMM based on the first caption;
converting the response to speech; and
causing a speaker to output the speech.

2. The method of claim 1, wherein detecting the trigger comprises at least one of:
detecting a mobile device or key fob entering the cabin environment by a communication channel between the mobile device or the key fob and the vehicle;
detecting an occupant entering the cabin environment by the one or more in-cabin cameras or by an in-cabin proximity sensor;
detecting an occupant speaking by an in-cabin microphone;
detecting the vehicle waking from a dormant state by a processor of the vehicle; or
detecting the vehicle departing from an origin or arriving at a destination by a global navigation satellite system (GNSS).

3. The method of claim 1, wherein the microphone comprises at least one of:
an in-cabin microphone; or
a microphone of a mobile device.

4. The method of claim 1, wherein the speaker comprises at least one of:
an in-cabin speaker; or
a speaker of a mobile device.

5. The method of claim 1, further comprising:
generating the response to the prompt by the LMM based on the first frame.

6. The method of claim 1, further comprising:
storing the first caption to a memory comprising at least one of:
an in-vehicle storage device; or
a cloud storage device.

7. The method of claim 1, further comprising:
generating a second caption for a second frame of either the first video or of a second video of the one or more videos by the LMM;
determining a similarity between the first caption and the second caption;
in response to the similarity exceeding a predefined threshold, discarding the first caption and storing the second caption to a memory.

8. The method of claim 1, further comprising:
generating a second caption for a second frame of either the first video or of a second video of the one or more videos by the LMM;
determining a difference between the first caption and the second caption;
in response to the difference exceeding a predefined threshold, generating a description of the difference by the LMM; and
generating the response to the prompt by the LMM based on the description.

9. The method of claim 1, further comprising:
storing the first frame to a memory comprising at least one of:
an in-vehicle storage device; or
a cloud storage device.

10. The method of claim 1, further comprising:
determining a similarity between the first frame and a second frame of either the first video or of a second video of the one or more videos;
in response to the similarity exceeding a predefined threshold, discarding the first frame and storing the second frame to a memory.

11. The method of claim 1, further comprising:
determining a difference between the first frame and a second frame of either the first video or of a second video of the one or more videos;
in response to the difference exceeding a predefined threshold, generating a description of the difference by the LMM; and
generating the response to the prompt by the LMM based on the description.

12. The method of claim 1, further comprising:
partitioning the first frame into a plurality of subframes; and
generating a plurality of first captions for the plurality of subframes by the LMM.

13. The method of claim 1, further comprising:
generating a plurality of first captions for a plurality of first frames of the first video by the LMM; and
storing at least one of the plurality of first captions or the plurality of first frames to a memory configured as a circular buffer.

14. The method of claim 1, further comprising:
generating a plurality of first captions for a plurality of first frames of the first video by the LMM;
storing individual ones of the plurality of first captions to a first memory at a first rate; and
storing individual ones of the plurality of first frames to either the first memory or a second memory at a second rate that differs from the first rate.

15. The method of claim 1, further comprising:
an individual one of the one or more in-cabin cameras comprises in infrared camera.

16. The method of claim 1, further comprising:
detecting the trigger that causes one or more in-cabin sensors to collect data for one or more properties of the cabin environment;
generating a description of the data for at least one of the one or more properties by the LMM; and
generating the response to the prompt by the LMM based on the description.

17. A system, comprising:
one or more memories; and
one or more processors configured to execute instructions stored in the one or more memories to:
detect a trigger that causes one or more in-cabin cameras to capture one or more videos of a cabin environment of a vehicle;
generate a first caption for a first frame of a first video of the one or more videos by a large multi-modal model (LMM);
receive a query concerning the cabin environment by a microphone;
convert the query to a text-based prompt;
generate a response to the prompt by the LMM based on the first caption;
convert the response to speech; and
cause a speaker to output the speech.

18. The system of claim 17, wherein the instructions include instructions to:
generate a plurality of first captions for a plurality of first frames of the first video by the LMM;
store the plurality of first captions to a first memory configured as a circular buffer at a first rate; and
store the plurality of first frames to either the first memory or a second memory configured as a circular buffer at a second rate that differs from the first rate.

19. A non-transitory computer-readable medium storing instructions operable to cause one or more processors to perform operations comprising:
detecting a trigger that causes one or more in-cabin cameras to capture one or more videos of a cabin environment of a vehicle;
generating a first caption for a first frame of a first video of the one or more videos by a large multi-modal model (LMM);
receiving a query concerning the cabin environment by a microphone;
converting the query to a text-based prompt;
generating a response to the prompt by the LMM based on the first caption;
converting the response to speech; and
causing a speaker to output the speech.

20. The medium of claim 19, the operations further comprising:
detecting the trigger that causes one or more in-cabin sensors to collect data for one or more properties of the cabin environment;
generating a description of the data for at least one of the one or more properties by the LMM;
storing the first caption and the description to a memory comprising at least one of:
an in-vehicle storage device; or
a cloud storage device; and
generating the response to the prompt by the LMM based on the description.
